(19) United States
(12) Patent Application Publication
(10) Pub. No.: US 2026/0107349 A1
(43) Pub. Date: Apr. 16, 2026

(54) INDUCTION SYSTEM

(71) Applicant: Kenyon International, Inc., Clinton, CT (US)

(72) Inventors: Daniel Roy, Westerly, RI (US); Michael Reischmann, Eustis, FL (US); Philip Williams, Clinton, CT (US)

(21) Appl. No.: 19/355,991

(22) Filed: Oct. 10, 2025

Related U.S. Application Data
(60) Provisional application No. 63/706,116, filed on Oct. 11, 2024.

(51) Int. Cl. H05B 6/12; H05B 1/02; H05B 6/04; H05B 6/06

(52) U.S. Cl. CPC H05B 6/1245; H05B 1/0202; H05B 6/04; H05B 6/062

(57) ABSTRACT

An induction heating device is provided with an induction coil and first capacitor, the first capacitor may be connected in parallel to the induction coil such that a voltage across the first capacitor and across the induction coil are substantially identical or may be connected in series and/or may be switchable between parallel and series, the induction coil and first capacitor define a first sub circuit. The induction coil may comprise two coils switchable between parallel and series configurations. An induction coil driver circuit is connected to the first sub circuit, the induction coil driver circuit generates an oscillating electrical current to generate heat in a cooking vessel which may be ferromagnetic or non-ferromagnetic (e.g. aluminum, copper, etc.).

### FIELD OF THE INVENTION

The present disclosure relates to an induction system which can be useful in an induction cooking apparatus. Particularly, the induction system proposed herein can operate with a variety of both voltages and cooking vessel types (e.g. different metals).

### BACKGROUND

Induction is a fast an effective way to generate heat, however most induction systems are designed for use in specific scenarios that are a combination of a defined voltage, power type and pan type (or heated element type). The most common induction system used for cooking operates at 120 v or 220 v AC and is designed for use with ferrous pans, particularly ferromagnetic pans or pans containing iron or steel alloys. The induction drive and coil will generate an oscillating magnetic field within a particular frequency range in order to induce current in the pan or item to be heated. If the wrong type of pan/material is used, the frequency range will either not work or be inefficient such that heating does not occur in the manner intended.

Furthermore, the induction drive is often geared towards use with a particular voltage and type of electrical power. For example, most cooking appliances use e.g. 120 v AC power. Other induction systems and drives may use higher voltages depending on the country and/or the application for the induction system. This leads to a requirement for a different controller, induction coil arrangement and induction drive for each different scenario and ultimately results in an inflexible cooking/heating system.

With the growing demand for green energy and electrical vehicles, both solar and DC batteries have become more and more prevalent as available energy sources. For example, marine vessels may have large battery banks used both to power the vessel and it would be preferable to draw DC power directly from those batteries to power cooking/heating appliances.

### SUMMARY

Accordingly, there is a need for a more flexible induction system and induction drive that can work with different pan/heated element types and also work with different voltage and power types to provide both added flexibility and efficiency.

For example, an induction system that works with both a variety of pan types (e.g. ferrous/steel, aluminum, copper etc), voltage ranges and voltage types (AC/DC) is desired. In order to accomplish this, the induction drive and controller needs to be able to determine what pan type is being used and then adjust the frequency of the oscillating current generated in the coil. Furthermore, the inductance of the coil may need to change as well in order to allow the system to operate efficiently in different scenarios. In a typical scenario, this level of flexibility would require variations in capacitors and induction coils used along with both the value and arrangement of the foregoing (e.g. series v. parallel arrangement). Further efficiencies can be obtained in some of the frequency ranges by arranging capacitors in a particular way (e.g. in parallel to the coil).

Therefore, the following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The cooking apparatus described hereinbelow, according to various embodiments, addresses various challenges facing previously employed induction heating/cooking devices.

For example, in one aspect, an induction heating device is provided and includes an induction coil and first capacitor connected in parallel to the induction coil such that a voltage across the first capacitor and across the induction coil are substantially identical, the induction coil and first capacitor define a first sub circuit. An induction coil driver circuit is connected to the first sub circuit, the induction coil driver circuit generating an oscillating electrical current.

In certain aspects the induction coil driver circuit is connected in series to a first side of the first sub circuit. In other aspects the induction coil driver circuit comprises a first field-effect transistor and a second field-effect transistor. In further aspects a second capacitor connected in series to the first sub circuit. In still other aspects a second capacitor is connected in series between the first sub circuit and an AC coupling circuit. In certain aspects the AC coupling circuit comprises a first capacitor, a second capacitor, a third capacitor, a fourth capacitor, a first resistor and a second resistor. In still further aspects, the first transistor is a high-powered high electron mobility enhancement-mode Gallium Nitride (GaN) transistor, abbreviated (E-mode GaN HEMT) and the second field-effect transistor is a high-powered (E-mode GaN HEMT). These are but some examples as other transistors such as field-effect transistors such as N-type MOSFETs and others can be used. In still further aspects a source of potential from an external high voltage AC-source is connected across a drain of the first field effect transistor to ground. In yet further aspects a second capacitor arranged in series with respect to the first sub circuit. In still other aspects the induction coil comprises first and second induction coils and the induction coil driver circuit further comprises a switch which switches the first and second induction coils between a parallel circuit configuration and a series circuit configuration.

In further aspects, an induction heating device is provided with a first induction coil, a second induction coil, a controller and a switch. In certain aspects the first and second induction coils are spaced and arranged such that they are magnetically coupled such that the magnetic field of the first induction coil interacts with the second induction coil, and the magnetic field of the second induction coil interacts with the first induction coil, for example using bifilar construction, by stacking, concentric or co-located arrangement or otherwise placing the first and second coils in close enough proximity for the generated fields to interact with each other, thus the coils can be spatially arranged so one field permeates the space of the other coil and vice versa. The first and second induction coils are switchable by the switch to change a combined inductance of the first and second induction coils. The controller is further configured to operate the first and/or second induction coils to generate an oscillating magnetic field. In certain aspects the induction coil has a predetermined inductance and the controller detects a measured combined inductance to determine if a cooking vessel is present and manipulates the switch based on the measured combined inductance. In still further aspects, the first and second induction coils are arranged in a stacked configuration. In certain aspects the controller comprises an induction coil driver circuit which is configured to generate an oscillating current and the controller is configured to manipulate the switch. In still further aspects the first and second induction coils are switchable by the switch from a parallel configuration to a series configuration.

In certain aspects an induction heating device is provided with an induction coil, a first capacitor and a switch. The first capacitor is switchable by the switch between first and second configurations, the first configurating having the first capacitor arranged in series with respect to the induction coil and the second configuration having the first capacitor arranged in parallel with respect to the induction coil. In certain aspects, a controller controls switching between the first and second configurations. In certain aspects, a second capacitor is arranged in series with respect to the induction coil. The device of Claim 16 wherein the induction coil comprises first and second induction coils and the first and second induction coils are switchable between parallel and series configurations. In still further aspects, the first and second induction coils are arranged in a stacked configuration. In yet other aspects the switch is selected from the group consisting of: a single pole double throw switch, a double pole double throw switch, a solid state relay, a field effect transistor. In further aspects, the device includes an induction coil driver circuit configured to generate an oscillating current and the controller is configured to manipulate the switch. In yet other aspects, the induction coil has a predetermined inductance and the controller detects a measured combined inductance to determine if a cooking vessel is present and manipulates the switch based on the measured combined inductance. In still other aspects the measured combined inductance is based on a combination of the predetermined inductance and an inductance of the cooking vessel.

Other objects of the invention and its particular features and advantages will become more apparent from consideration of the following drawings and accompanying detailed description.

### DRAWINGS

FIG. 1A shows high level overview of the induction system of according to various embodiments.

FIG. 1B shows details on the induction circuit of FIG. 1A.

FIG. 2 shows the induction circuit of FIG. 1A configured for ferrous cooking

FIG. 3 shows the induction circuit of FIG. 1A configured for non-ferrous cooking (e.g. aluminum).

FIG. 4A-4F show various resulting configurations depending on how the relays and switches of FIG. 1A are configured.

FIG. 5 shows one example induction drive circuit according various embodiments herein.

FIG. 6 provides a plot of the impedance of the circuit in FIG. 5.

FIG. 7 shows the current gain in the induction coil of FIG. 5.

FIG. 8 is a cross section view of a portion of an exemplary induction cooker for popcorn which may make use of the circuitry and systems described and shown in FIGS. 1-7.

FIG. 9 is a detail view of FIG. 8

FIG. 10 is a cross section view of the induction cooker of FIG. 8.

FIG. 11 shows an exemplary process flow for the controller of FIGS. 1 and 10.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

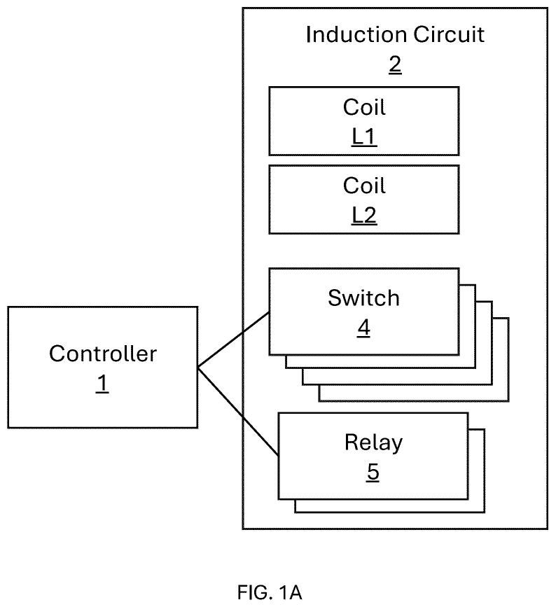

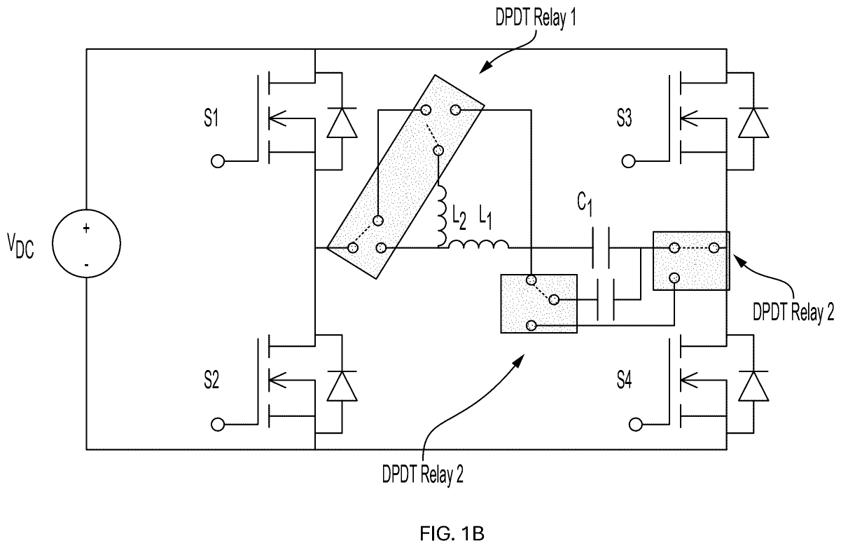

As shown in FIG. 1A, an induction cooking/heating apparatus is shown. This system includes a controller 1 which manipulates the various switches 4 and relays 5 to control the coil(s) L1, L2. The Switches 4 in FIG. 1A correspond to S1-S4 (which may be field effect transistors) shown in FIG. 1B and the Relays 5 shown in FIG. 1A correspond to the DPDT Relays 1 and 2 shown in FIG. 1B. The controller is configured to operate these different switches and relays to effectively change the circuit topology of the induction circuit 2, depending on the arrangement of the various switches/relays. It should be understood that although a particular type of relay and switch is shown, it is understood that various types of switching devices whether they be solid state relays, mechanical relays, transistors (FET, MOSFET, E-mode GaN HEMT etc) or other devices capable of switching/directing current/potential can be used as one of skill in the art would understand. A MOSFET is a metal-oxide-semiconductor-field-effect transistor as known by those of skill in the art. An E-mode GaN HEMT is a high electron mobility enhancement-mode Gallium Nitride (GaN) transistor.

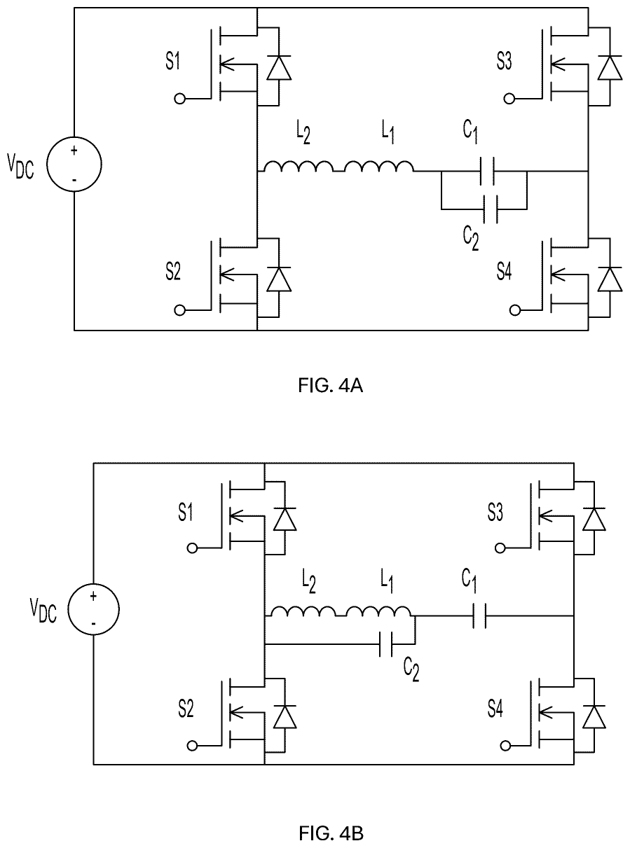

As shown in FIG. 1, the induction coils L1 and L2 are in a stacked configuration. This allows the system to vary the inductance by changing the effective circuit topology of the induction coil sub circuit. Namely, the coils L1 and L2 may be arranged in series or parallel, the inductance of the coils may also be different and in this manner, there are further options of selecting one or the other coil while not using the other. Thus, both coils in series, both coils in parallel, one coil or the other coil are available options depending on the relay configuration. A similar benefit is provided for the capacitors C1 and C2 in that the capacitors may be in series (FIG. 3) with the induction coil, alternatively, once capacitor may be in parallel with the coil with the other capacitor in series. Again, this depends on the switch/relay configuration.

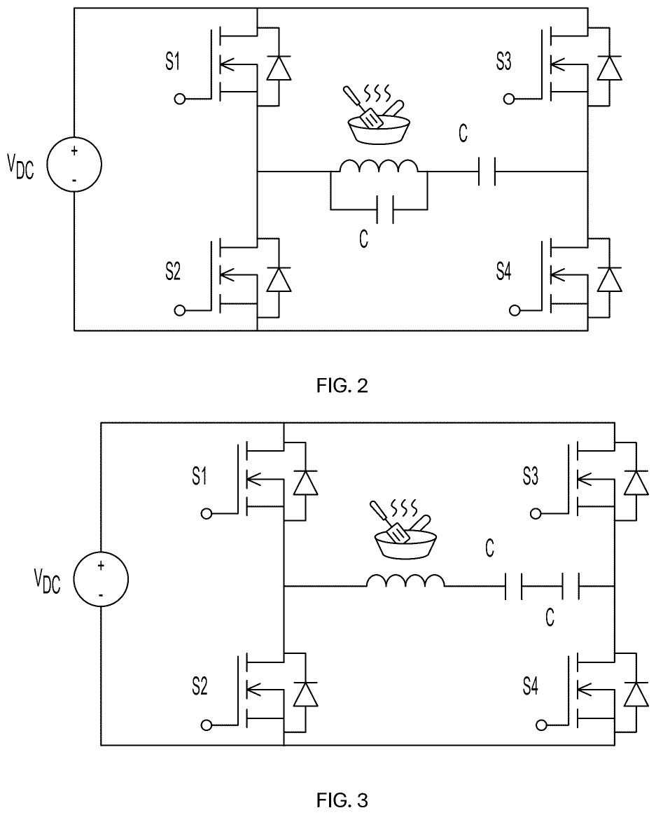

FIG. 2 shows an example of a DC based cooking device for use with ferrous pans. Here, a full bridge series/parallel resonant inverter is used, and the frequency is set to a relatively low frequency, e.g. in the 10-40 KHz range, preferably 18-40 KHz, more preferably 20-40 KHz. In preferred embodiments, the minimum frequency is set to 20 KHz, which is not audible to humans. Here, the controller 1 measures the combined inductance of the pan and coils in order to manipulate the switches and relays to achieve the topology shown in FIG. 2. Here the capacitors are equal, one in parallel with the coil, the other in series. Further, as explained previously, the coil may be two coupled coils, for example, a bifilar construction such that the coil is really two induction coils connected in series. By knowing the arrangement of the relays, the controller can determine the combined inductance of the pan and coils. From this measured combined inductance, it can be deduced what type of pan is on the cooktop and the relays/switches manipulated accordingly. Thus, FIG. 2 shows the result of a ferrous cooking vessel being detected.

FIG. 3 shows what happens instead when a non-ferrous cooking vessel is detected, for example, aluminum or another metal with high conductivity. In order to generate sufficient heat to function properly, the frequency needs to be increased substantially. As shown in FIG. 3, the capacitors are switched to a series configuration. Furthermore, the induction coils are switched to be in a parallel configuration. As a result, the inductance is increased four times by the coupled coils, specifically parallel wiring of the coils. Further, by moving the parallel capacitor to instead be in series, the capacitance is cut in half. The net result can be at least a 1.5× increase in resonant frequency, more preferably at least a 2× increase, even more preferably at least a 5×, at least an 8× or at least 10× and on the upper end up to 15× and all combinations of these ranges in increase in resonant frequency are contemplated. Furthermore, the inductor resistance is reduced substantially due to the parallel configuration. Here again, the controller knows the configuration of the various relays/switches and then can detect the inductance of the combined system (coils and pan together). This measured combined inductance can then indicate if a ferrous or non-ferrous pan is present, allowing the controller to manipulate the switches/relays accordingly.

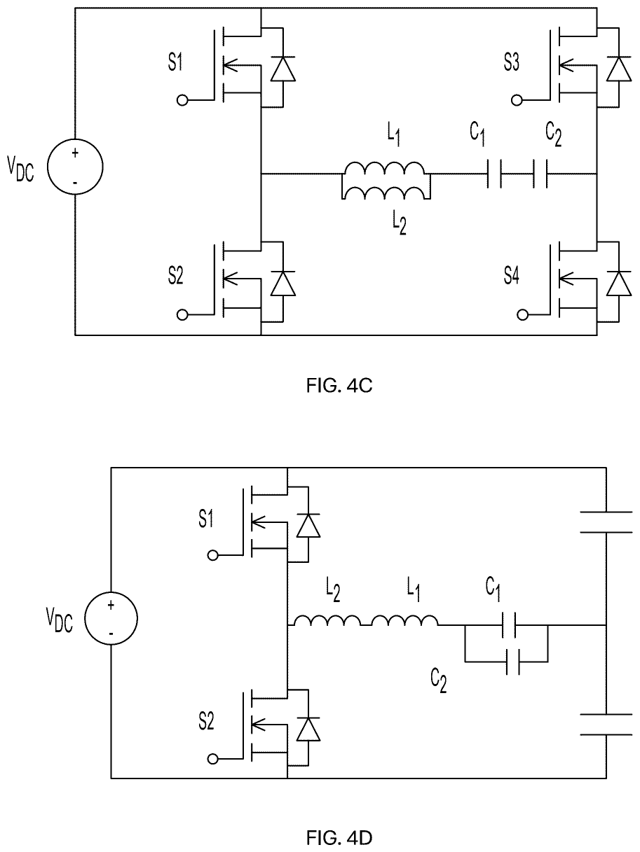

Referring to FIG. 4A-D, different resulting configurations from various switch positions are shown. Namely, FIGS. 4A and 4B show the induction coils switched in a series configuration, in FIG. 4A, the Capacitors C1 and C2 are in parallel with each other and in series with respect to the induction coils. FIG. 4b shows the capacitor C2 switched to be in a parallel configuration with the induction coils with Capacitor C1 in series with respect to this capacitor and coil sub circuit. FIG. 4C shows the coils L1 and L2 in a parallel configuration with capacitors C1 and C2 in series, FIG. 4D shows the coils L1 and L2 in series with the capacitors C1 and C2 in parallel with each other and S3 and S4 are replaced with capacitors. FIG. 4A provides a circuit topology which is usually useful for ferrous metal cooking. FIG. 4B in comparison to FIG. 4A provides current gain such that the current through the coil is greater than that running through any of switches S1-S4. The FIG. 4C circuit includes parallel coils and series capacitors to result in a increase of resonant frequency in a substantial amount, for example 3× or more, preferably about 4×. When a high conductivity pan (e.g. aluminum or copper) is placed on the coil, the resulting magnetic field reduces the inductance and increases the resonant frequency. FIG. 4D provides a higher voltage option, preferably high voltage DC, e.g. 48v or higher, preferably 56 v or higher or even more preferably 72 volts or higher.

FIG. 4E is similar to FIG. 4D but the capacitor C2 is in parallel with the coils as a sub circuit. This provides the current gain benefits and is useful for the similar high voltage ranges described with respect to FIG. 4D and can be used in non-ferromagnetic cooking, for example with aluminum or copper or other materials with high conductivity. FIG. 4F is similar to FIG. 4C and provides for a resonance frequency that may be even better at cooking with non-ferromagnetic materials such as aluminum and copper than FIG. 4E. This again may be suitable for higher voltages.

In preferred embodiments, the controller will be configured to switch between FIG. 4A and FIG. 4C configurations. As can be seen, the components of the circuit remain active and used in both configurations and are not switched out of the circuit. Here, FIG. 4A is used for ferrous DC cooking at relatively low voltages (e.g. at or below 72 v, at or below 56 v or at or below 48 v). FIG. 4C is used for similarly low voltage DC cooking with non-ferrous cooking vessels/elements. In order to determine this switching need, the controller can measure the combined inductance of the pan and coil and then manipulate the switches/relays accordingly. Another option is to switch between FIG. 4B (for ferrous) and FIG. 4C for non-ferrous cooking.

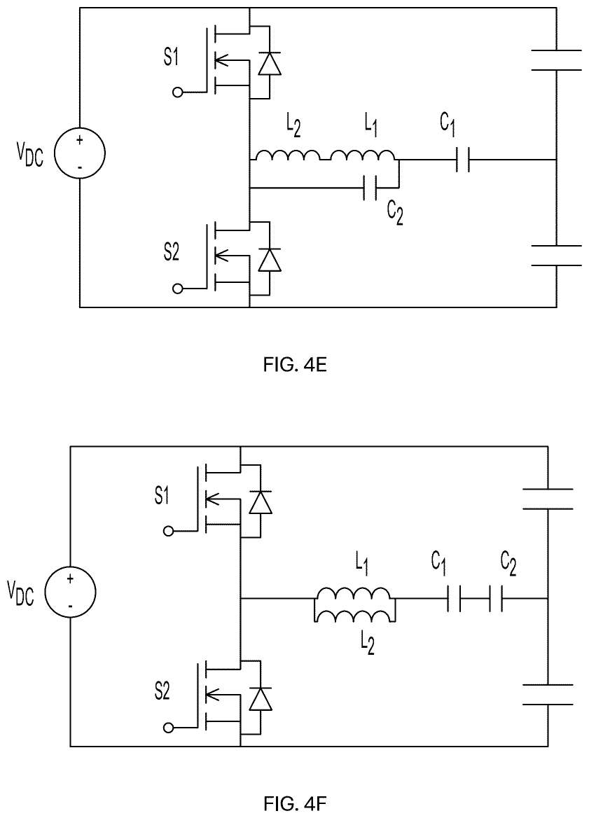

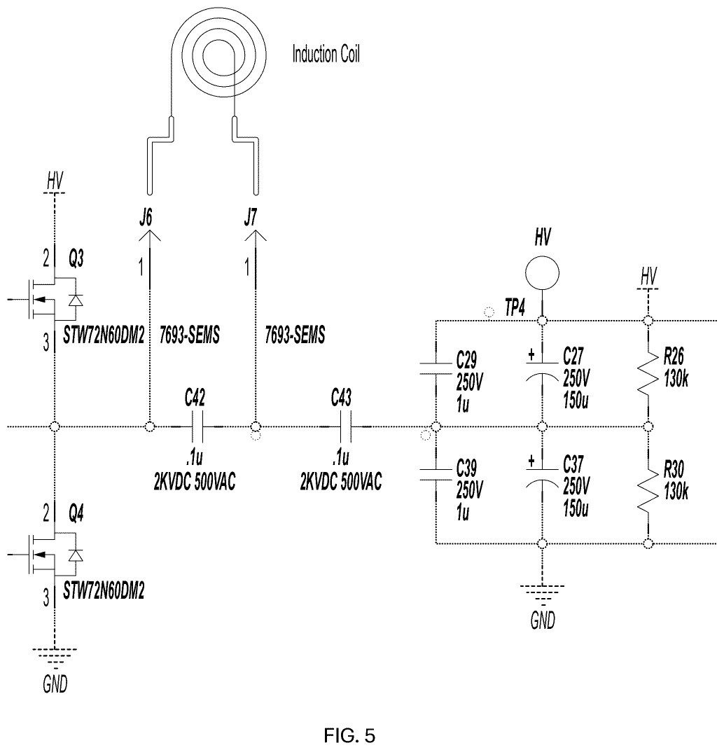

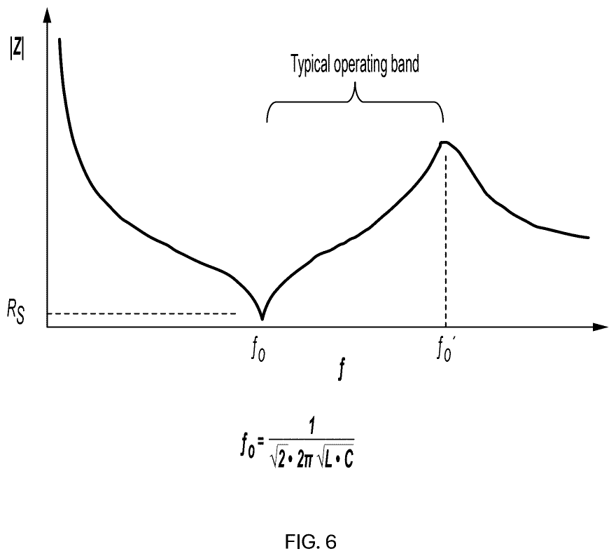

FIG. 5 shows a specific implementation of FIG. 4E with specific values of the various capacitors and system components. As shown C42 and C43 form a series/parallel resonant circuit with the induction coil's inductance to control the impedance seen by the drive circuit (Q3 and Q4). In addition, this arrangement provides overall current gain within the induction coil, such that the RMS current in the induction coil is as much as twice the RMS current flowing through C43, Q3, and Q4. This current gain serves to increase the efficiency of the circuit. The conduction losses in Q3 and Q4 are proportional to current squared, so reducing the current by a factor of two (using the C42 and C43 to provide current gain), the conduction losses in Q3 and Q4 are reduced by a factor of four. FIG. 6 provides a plot of the impedance of the circuit in FIG. 5. In FIG. 6, L is the inductance of the combination of the induction coil and the cooking vessel. The vessel is magnetically coupled to the induction coil so it effects the inductance. C is the capacitance of C42 and C43 which are equal. The current gain in the induction coil is shown in the plot at FIG. 7. Importantly, at f-naught, the current flowing through the induction coil is twice the current flowing through Q3 and Q4. In FIG. 5 C42 represents the parallel resonant capacitor and C43 the series resonant capacitor. C37 as show is an example of an AC Coupling capacitor. HV here represents full wave rectified 120 VAC.

It is further understood that the configurations of the various half and/or full bridge circuits shown in FIGS. 4A-F may not employ the relays 5 (DPDT Relays of FIG. 1B) and may instead be fixed circuit configurations or may employ fewer relays to allow switching of the capacitor between series and parallel but not switching of the coil or switching of the coil between series and parallel and not of the capacitor or switching of both as shown in FIG. 1B. In some cases as shown, switches S3 and S4 are replaced with capacitors as shown in FIGS. 4D-4F.

The in preferred embodiments for non-ferrous cooking (e.g. aluminum), the size (diameter) of the induction coil is such that the magnetic field created couples fully to the vessel, and doesn't “spill” around the vessel. The induction coil's nominal inductance is a function of its diameter, the number of turns, and what backing material is used. Given that the diameter is driven in large part by the diameter of the cup/vessel, the number of turns is selected to provide sufficient inductance to create a strong enough magnetic field to induce enough current in the vessel to cause sufficient heating. The resonance frequency, F-naught, is selected such that the frequency of the induced current is high enough that it's forced to flow in the lower layer of the bottom of the cup due to the skin effect. Because the current is constrained to this very thin layer, the net resistance seen by the induced current is relatively high. This results in the I\hat{ }2*R losses being sufficiently high to dissipate enough power to heat the vessel for cooking.

Because the magnitude of current induced is a function of the drive frequency, the drive frequency can be adjusted to control the current in the vessel/cup as well as the resulting power dissipation and temperature. As the temperature of the vessel/cup increases the net resistance of the vessel/cup increases causing the induced current to decrease and the power dissipated to decrease. If the operating frequency is not adjusted to increase the current proportionally, the vessel temperature will decrease, interrupting the cooking process. Thus, the controller will adjust the operating frequency over time.

Generally speaking, the initial operating frequency is selected to be substantially above the f-naught frequency. Over the course of the cooking cycle the operating frequency is gradually reduced.

The induction coil may be “backed” by a high permeability, low conductivity material such as ferrite ceramic. This ceramic backing serves multiple purposes including providing a low-reluctance return path for the magnetic flux generated by the induction coil, to prevent excessive magnetic flux from coupling electrical components residing below the induction coil assembly, and to provide some thermal mass for the induction coil heat to flow into.

In the non-ferromagnetic cooking implementations, the induction process uses skin effect to cause resistance losses only (e.g. only eddy current losses) instead of ferromagnetic cooking's hysteresis and eddy current losses. In ferromagnetic cooking, the current in the induction coil is controlled by adjusting the frequency of operation of the coil assembly, particularly. As the drive frequency is reduced from above the resonance frequency down towards the resonance frequency, the current increases. Operating above resonance frequency, (where resonance frequency is the frequency at which the energy stored in the induction coil's net coupled magnetic field is equal to the energy stored in the tuning capacitors'combined electric fields) results in the tuned coil assembly have a net inductive reactance, allowing the drive circuit to stay in soft switching mode which increases efficiency. Furthermore, the current in the induction coil and the resulting power may be controlled by modifying the duty cycle of the drive circuit (e.g. making this longer or shorter periods to modify the power).

In preferred embodiments, the induction coil driver and controller applies a voltage across the induction circuit. The quantity of current produced at a given drive frequency depends on the impedance of the induction circuit. The impedance of the induction circuit is different if a cup is present or absent. Therefore by detecting the amount of current flowing at a certain “test” or “vessel detect” frequency, the microcontroller can determine whether a vessel is present and whether that vessel requires the ferromagnetic circuit topology or the non-ferromagnetic topology.

In the popcorn popping arrangement in a single use cup, the controller can detect how much product is in the cup and adjust the power delivered, stirring time/frequency, and temperature profile accordingly. As one example, there are nominally four quantities. Namely, empty cup, single serving, double serving, or triple serving.

Detection of an empty cup is achieved as follows. The test frequency is used and the current monitored, identically to the cup detect mechanism. If the cup is empty it floats to the top of the receptacle and the test current is out of range indicating an empty or absent cup.

### Detection of a Single, Double, or Triple Serving Cup:

Method 1: Detection of a single, double, or triple serving cup, or an empty cup, can be achieved by applying a unit of current to the voice coil to create a Lorentz force to move the cup away from the induction coil. Because the force due to gravity is opposing the Lorentz force, the net force is the Lorentz force−force due to gravity=net force. The net force is working into the stiffness of the silicone receptacle. The force on a spring is equal to the displacement times the stiffness, so the displacement is equal to the force divided by the stiffness. A single serving moves further away from the induction coil than a double serving, the double serving moves further away than a triple serving because the single serving is lighter than the double serving which is lighter than the triple serving. An empty cup moves further still, as it is lightest of all. While the voice coil is energized with a unit of current, the induction coil is energized at the test frequency and the resulting induction-coil-current is measured. Depending on what frequency is used to energize the induction coil, the current will either increase or decrease with increasing cup to induction coil distance. Practically, the resulting current from energizing the coil at the test frequency is characterized in the laboratory and a lookup table is used in the production unit. The test current is measured and compared against a lookup table.
Method 2: Depending on the type of cup used (for example, if a paperboard cup with a foil laminate is used), simply displacing the cup with the vibrator coil may not yield sufficient change in test current to discriminate between the serving sizes. In this case a differential measurement can be made whereby the induction coil is energized with no vibrator coil current, then again with 1 unit of vibrator coil current, and then again with 2 units of vibrator coil current. The slope of induction coil current vs vibrator coil current will be proportional to the weight of the cup. In preferred aspects, the cup-detect and serving size detection mechanisms take only a few moments to complete, order 1 second. They do not appreciably add to the overall cooking time.

The temperature of the cup can also be determined either via specific contact sensors or more preferably the temperature may be inferred. The resistance of the cup is a function of temperature and thus the measured inductance of the overall combination of the coil and the cup, and the rate of change thereof will change based on how hot the cup is. The effect that distance of the cup to the induction coil has on the coil current is a function of the cup resistance. To infer the temperature of the cup, the popper can measure the change in slope of an induction coil test current. Furthermore, the vibrator mechanism may be used initially to move the cup to determine how much current needs to be applied to the vibrator and its corresponding change in inductance as the cup is moved away from the coil. All of this information may be used to identify the cup's characteristics and then infer temperature based on how inductance changes over time during cooking. Namely, when the cup is colder the slope of the curve is higher than when it's hotter. A calibration curve can then be used to determine the slope of the induction coil test current vs voice coil current as a function of cup temperature and the results may be stored in a lookup table on the controller, allowing for the controller to determine temperature of cooking and adjust frequency and power accordingly.

The heating mechanism for the aluminum vessel is high-frequency induction. Time-changing magnetic fields from the induction coil are coupled to the conductive (aluminum) vessel. Via Faraday's Law of Induction, a current is induced in the vessel. This current causes resistive heating of the cup. The resistive heating power is proportional to the vessel current squared times the net resistance of the current path in the vessel. The magnetic coupling of the vessel to the induction coil is highly dependent on distance, and to a first order, the coupling falls off at 1/distance (i.e. falls off with the inverse distance). As characterized by Faraday's Law of Induction, the induced voltage and therefore current are directly dependent on the coupling coefficient. Changing the coupling directly changes the vessel current. Because the vessel heating power is proportional to vessel-current squared, the heating power changes as the inverse distance squared.

To enhance the resistive losses in the cup, high frequency magnetic fields are used (about 10 times higher than typical induction heaters). Due to the Skin-Effect, the relatively high frequency keeps the current density closer to bottom surface of the cup which decreases the cross-sectional area of the current path, thereby increasing the resistance. In one example more than 50% or more than 60% or about 63% of the current flows within 1 skin depth. Skin depth is a function of both the conductivity and permeability of the material.

The induced current within the vessel circulates such that the resulting magnetic field is opposed to the field that induces the current. The total magnetic field is the sum of that from the induction coil, plus that from the vessel-current. Because the vessel-current field is opposed to the induction coil field, the net magnetic field is less than it would be in the absence of the vessel.

Inductance is the magnetic flux coupled to a conductor (or coil) per ampere of current within the conductor (or coil). It is therefore evident that the presence of the vessel, whose induced current creates a magnetic field that cancels a portion of the induction coil's field, that the induction coil's inductance is reduced by the presence of the vessel.

The resistivity of the k-cup increases with temperature, which increases the resistance of the induced vessel current path. For a given or set time rate of change of flux, the induced voltage on the vessel is fixed. The resulting current is the induced voltage divided by the net resistance.

Therefore, for a given operating frequency and induction coil current, as the k-cup temperature increases, the induced vessel current decreases. The reduction in vessel current results in a reduction in the opposing magnetic field which results in an increase in the net magnetic field. The increase in the net magnetic field yields a higher induction coil inductance.

At a set frequency and induction coil current, the vessel has an induced current that heats the vessel, increasing its temperature. The increase in temperature results in a lower induced current. The lower induced current cancels less of the induction coil field. The increased net induction-coil field per unit of current represents an increase in the induction coil inductance.

End of cooking can be detected as well. Two examples include: First: when the cup is empty it levitates away from the induction coil and the coil current changes. This change is detected and cooking stops. The disadvantage of this mechanism is that oil or deformations of the cup resulting from rough handling or shipping may impede the cup from levitating away from the induction coil. Second: The same mechanism used to detect serving size can be done mid-cook cycle. Simply add a unit of current to the voice coil and measure the change in current. Since the cup will be at an elevated temperature, the percent change in current should be used instead of the absolute change in current. This mechanism works is because the popcorn is ejected from the cup as it cooks, so the weight of the cup is reduced as is cooks.

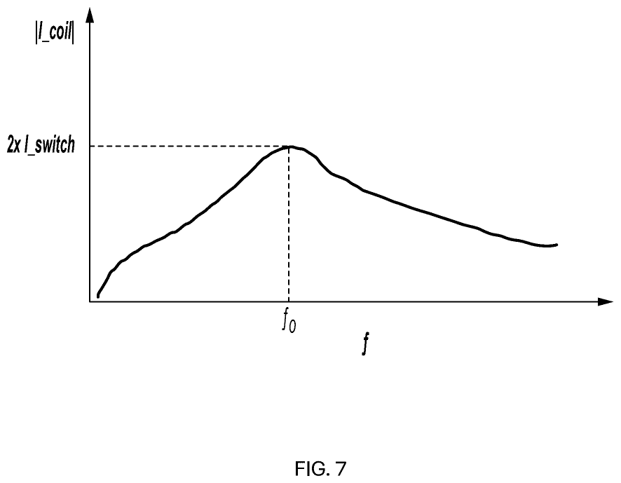

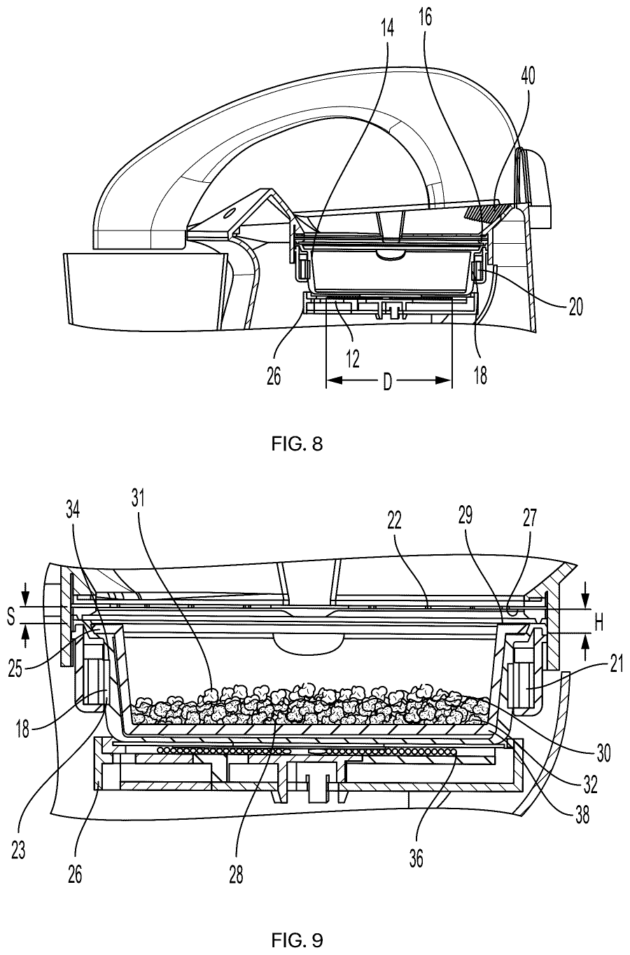

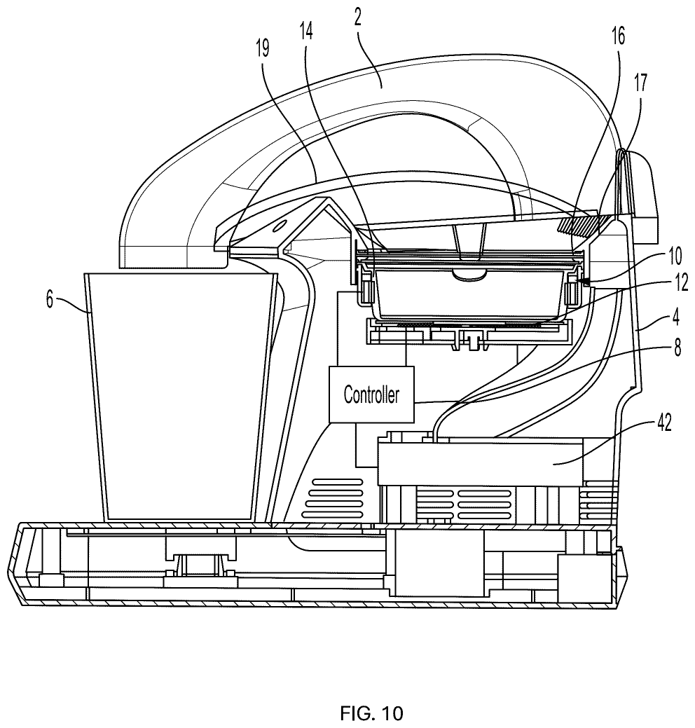

In FIG. 10 and in further detail in FIGS. 8 and 9, an exemplary induction cooking apparatus is shown. In the particular embodiment, a popcorn cooker is provided with a housing 4 and a hinged lid 2 along with a receiving cup 6. Within the housing, a support 14 for a cooking vessel is provided. In preferred embodiments the material used for the support 142 is flexible and/or elastomeric, for example silicone rubber or another similar material. Preferably a non-metallic and non-conductive material is used for the support 14. The induction coil 12 is positioned below the support 14. A vibration device 10 is positioned above the induction coil 12. A controller 8 is provided within the housing 4 and is connected to the vibration device 10, the fan 42 and the induction coil 12. As needed, the controller coordinates operation between the vibrator 14, the fan 42 and the coil 12 in order to cook the food, in this example, popcorn.

At the upper end of the support 14 is a retaining device 16 which is provided to hold the vessel in place during operation of the cooking cycle.

The fan 42 is operated, sometimes during cooking, in order to assist the popped kernels in moving towards the serving cup 6. The fan blows air out the vent 17, generally along the path 19 to assist in this movement of the popped kernels.

As can be seen in FIGS. 8 and 9, a support 26 is provided for the induction coil 12. This support 26 holds the coil 12 in close proximity to the underside of the support 14 for the vessel. The width (or diameter) D of the coil 12 is less than that of the support 14. Notably, the support is sized to receive the vessel therein and thus when inserted into the support 14, the vessel blocks the pathway from the outermost portion of the coil 36 to the lower portion of the vibrator apparatus 18, particularly the coil/magnet of the vibrator. Notably, the lower and outer portion 38 of the vessel is positioned along a path (ideally along the straight path) between the outermost portion 36 and the lowermost portion 23. Since the vessel is made of a conductive material, its presence blocks or inhibits the magnetic field generated by the induction coil 12 from impacting the vibrator 14.

The vibrator 14 is a combination of two parts 18/21, namely a coil 21 and magnet 18. The support 14 includes a recess 34 in its outer surface. The magnet 18 fits in this recess 34 so that as the coil 21 is activated by the controller 8, the magnet 18 moves up and down to vibrate the support 14 which thereby vibrates the vessel 28. As shown, the vessel is provided with a combination of popcorn 30, seasoning 31 and a cooking fat such as oil 32.

As can be seen, the retainer 16 is positioned above the support 14 such that a lower portion 27 of the retainer is spaced a distance H away from the surface 25 of the support 14. This surface 25 is sized to mate with a lower surface of a flange/ring/lip 29 on an outer side of the vessel. The upper surface of the flange/ring/lip 29 is then spaced distance S away from the lower surface 27 of the retainer 16. In this manner, the vessel 28 can float slightly when a magnetic field is generated by the coil 12. This floating allows the vessel 28 to move away from the coil 12 and as a result, the combined inductance of the coil 12 and vessel 28 changes based on how far the vessel floats away. This change in inductance can indicate that the vessel 28 is empty when cooking is finished or can be used to determine the weight of the vessel 28 when full (or when part way through cooking) in order to determine how much time is needed to cook the popcorn and/or what cooking program is used by the controller 8. In preferred aspects, the distance H is 1.1-3 times that of distance S, preferably 1.2-2.5, more preferably 1.3-2.25. The controller depicted in FIG. 10 may also house one or more components of the induction circuit 2 as shown in FIGS. 1B-4E with the coil 12 representing L1 and L2 as shown in prior figures.

In certain embodiments shown, the induction circuits 2 are useful for DC powered devices of various voltages. In other embodiments, the circuits 2 shown may be suitable for AC power.

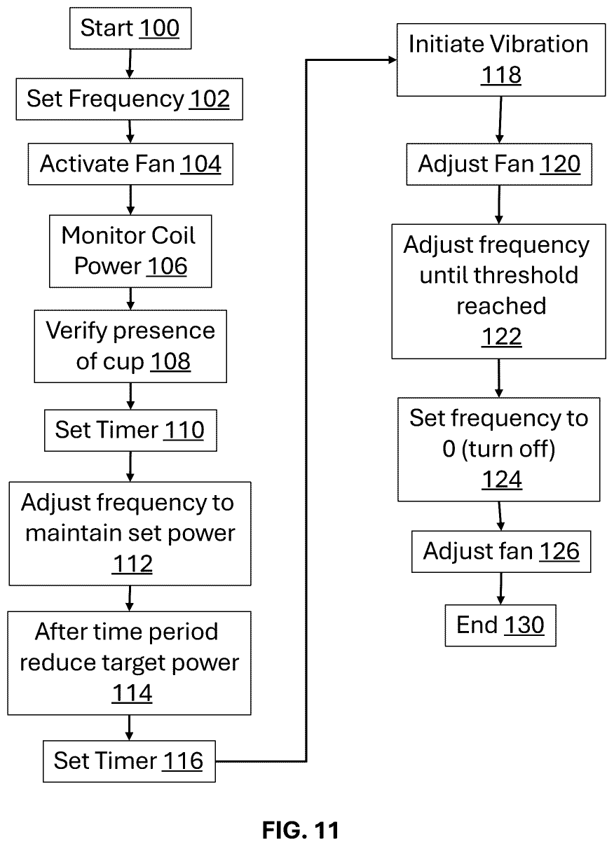

Referring to FIG. 11, in certain aspects, the system is configured to cook popcorn in an aluminum or other non-ferrous cooking vessel and the controller implements a cooking process to automatically cook the popcorn. On initial start 100, a frequency will be selected 102 for the induction coil and the current will be measured to monitor coil power 106. Given the known starting frequency and wattage, there should be a known current or a value within a threshold or range. If the current detected does not match what is expected, an error may be returned and the system shut off. This may indicate that no cup is present. If no error is detected initially this can be a verification that the cup is present 108. A timer is set 110 and the induction coil continues with the starting frequency and adjusts the frequency 112 down over time as the temperature of the vessel increases (which increases resistance). After the first timer is finished (or a predetermined time elapses), the power may be reduced 114 and another timer started 116 (or a second predetermined time is counted), over this second timer period, the frequency continues to be adjusted lower to maintain the target power 122. Within the second timer period, a vibrator mechanism may be used 118 to vibrate the vessel. Then, a third timer (or time period) is tracked and another power setting is maintained 122. During this third time period the frequency is adjusted lower to maintain the target power. Once the frequency drops below a threshold (or the timer expires), the cooking ends 122. Notably, the cup/vessel may be levitating if it is light enough given that the popcorn may have cooked and popped out of the vessel. The power/current is set to 0 and the vibrator turned off 124. A fan may blow 126 to cool the system off until the end of the cooling timer 130. One specific implementation that software executing on a processor of the controller may implement a program which includes the following steps, for example:
1. User presses button to start
2. Set cooking frequency to 170 k
3. Set fan to 20%
4. Set target coil power to 200 W
5. delay of 0.5 s
6. if current is >threshold:
7. set error due to no ramekin/vessel/cup
8. else
9. start 45 s timer
10. while timer is running:
11. every 100 ms adjust cooking frequency lower to increase power and maintain the target
12. set target power to 175 W
13. set timer to 95 seconds
14. while timer is running:
15. every 100 ms adjust cooking frequency lower to increase power and maintain the target
16. when 15 seconds remain on the timer, enable the voice coil driver to begin operating at 32 Hz with a 750 ms on time and 5000 ms off time
17. Set fan to 85%
18. set timer to 115 seconds
19. while timer is running:
20. every 100 ms adjust cooking frequency lower to increase power and maintain the target
21. if the cooking frequency drops below a threshold(was 120 kHz, currently 105 kHz during 8 oz testing) then end the timer because the popping process has completed because the cup is levitating in the magnetic field
22. disable cooking frequency by setting to 0 Hz
23. disable voice coil driver
24. set fan to 40%
25. set timer to 30 s
26. while timer is running:
27. run the fan to help cool down the entire system.
28. Set fan to off(0%)
29. Go to idle state waiting for user to press button to start popping process.

The heating of an aluminum cooking vessel works by eddy currents which are induced by magnetic fields generated by a high frequency induction coil. The power delivered to the aluminum cooking vessel is proportional to the square of the induced eddy current magnitude. The eddy current magnitude falls off with the inverse of distance and the power delivered to the aluminum vessel falls off with the inverse distance squared. Accordingly, the power delivered to the aluminum vessel is proportional to the net resistance seen by the eddy currents. The net resistance is a function of the operating frequency due to the skin effect. With a relatively thin cup, the resistance due to thickness would not vary substantially because of a relatively narrow operating bandwidth and relatively thin vessel such that the skin effects and related resistances based on thickness would be predictable. However, the net resistance is a function of vessel temperature, with resistance increasing with temperature.

The series/parallel switching provided herein creates a frequency-dependent impedance so that current can be controlled by variation of the operating frequency. Current gain in the coil relative to the total branch current is also provided, thus reducing the conduction losses in the switches (which may be field effect transistors—FETs). The series/parallel switching described herein further provides an inductive load in the operating frequency band which reduces switching losses in the FETs.

Although the invention has been described with reference to a particular arrangement of parts, features and the like, these are not intended to exhaust all possible arrangements or features, and indeed many other modifications and variations will be ascertainable to those of skill in the art.

What is claimed is:

1. An induction heating device comprising:
an induction coil and first capacitor connected in parallel to the induction coil such that a voltage across the first capacitor and across the induction coil are substantially identical, the induction coil and first capacitor define a first sub circuit;
an induction coil driver circuit connected to the first sub circuit, the induction coil driver circuit generating an oscillating electrical current.

2. The device of claim 1 wherein the induction coil driver circuit is connected in series to a first side of the first sub circuit.

3. The device of claim 1 wherein the induction coil driver circuit comprises a first field-effect transistor and a second field-effect transistor.

4. The device of claim 1 comprising a second capacitor connected in series to the first sub circuit.

5. The device of claim 1 wherein a second capacitor is connected in series between the first sub circuit and an AC coupling circuit.

6. The device of claim 5 wherein the AC coupling circuit comprises a first capacitor, a second capacitor, a third capacitor, a fourth capacitor.

7. The device of claim 1 wherein the induction coil driver circuit is configured to measure a net resistance of the induction coil and a cooking vessel at a frequency of the oscillating electrical current to determine a temperature of the cooking vessel.

8. The device of claim 7 wherein a source of rectified AC potential or a source of DC potential of at least 40 v is connected across a drain of the first field effect transistor to a source of the second field effect transistor.

9. The device of claim 1 wherein the induction coil comprises first and second induction coils which are spatially arranged such that when activated the first and second induction coils are magnetically coupled.

10. The device of claim 1 wherein the induction coil comprises first and second induction coils and the induction coil driver circuit further comprises a switch which switches the first and second induction coils between a parallel circuit configuration and a series circuit configuration.

11. An induction heating device comprising:
a first induction coil;
a second induction coil;
a controller;
a switch;
the first and second induction coils are switchable by the switch to change a combined inductance of the first and second induction coils;
the controller configured to operate the first and/or second induction coils to generate an oscillating magnetic field.

12. The device of claim 11 wherein the induction coil has a predetermined inductance and the controller detects a measured combined inductance to determine if a cooking vessel is present and manipulates the switch based on the measured combined inductance.

13. The device of claim 11 wherein the first and second induction coils are spatially arranged such that when activated the first and second induction coils are magnetically coupled.

14. The device of claim 11 wherein the controller comprises an induction coil driver circuit which is configured to generate an oscillating current and the controller is configured to manipulate the switch.

15. The device of claim 11 wherein the first and second induction coils are switchable by the switch from a parallel configuration to a series configuration.

16. The device of claim 11 wherein the controller is configured to measure a net resistance of the induction coil and a cooking vessel at a frequency of the oscillating magnetic field to determine a temperature of the cooking vessel.

17. An induction heating device comprising:
an induction coil;
a first capacitor;
a switch;
the first capacitor switchable by the switch between first and second configurations, the first configurating having the first capacitor arranged in series with respect to the induction coil and the second configuration having the first capacitor arranged in parallel with respect to the induction coil.

18. The device of claim 17 further comprising a controller which controls switching between the first and second configurations.

19. The device of claim 17 further comprising a second capacitor arranged in series with respect to the induction coil.

20. The device of claim 17 wherein the induction coil comprises first and second induction coils and the first and second induction coils are switchable between parallel and series configurations.

21. The device of claim 20 wherein the first and second induction coils are spatially arranged such that when activated the first and second induction coils are magnetically coupled.

22. The device of claim 17 wherein the switch is selected from the group consisting of: a single pole double throw switch, a double pole double throw switch, a solid state relay, a field effect transistor.

23. The device of claim 17 further comprising an induction coil driver circuit configured to generate an oscillating current and the controller is configured to manipulate the switch.

24. The cooking device of claim 23 wherein the induction coil has a predetermined inductance and the controller detects a measured combined inductance to determine if a cooking vessel is present and manipulates the switch based on the measured combined inductance.

25. The cooking device of claim 24 wherein the measured combined inductance is based on a combination of the predetermined inductance and an inductance of the cooking vessel.

26. The cooking device of claim 24 wherein the induction coil is a first coil and a second induction coil is provided and configured to heat ferrous cooking vessels.

27. The device of claim 17 further comprising a controller which is configured to control power delivered to the induction coil is further configured to measure a net resistance of the induction coil and a cooking vessel at a frequency of an oscillating electrical current in the induction coil to determine a temperature of the cooking vessel.
